(19) United States
(12) Patent Application Publication
(10) Pub. No.: US 2016/0085845 A1
(43) Pub. Date: Mar. 24, 2016

(54) SERVER APPARATUS, DATA AGGREGATION METHOD, AND COMMUNICATION DEVICE

(71) Applicant: CASIO COMPUTER CO., LTD., Tokyo (JP)

(72) Inventor: Hiroaki YOSHIZAWA, Ome-shi (JP)

(73) Assignee: CASIO COMPUTER CO., LTD., Tokyo (JP)

(21) Appl. No.: 14/855,084

(22) Filed: Sep. 15, 2015

(30) Foreign Application Priority Data
Sep. 19, 2014 (JP) 2014-191868
Sep. 19, 2014 (JP) 2014-191879
Nov. 26, 2014 (JP) 2014-239297

(51) Int. Cl. G06F 17/30; H04L 29/06; H04L 29/12

(52) U.S. Cl. CPC G06F 17/30598; G06F 17/30554; H04L 61/2069; H04L 65/4069

(57) ABSTRACT

According to an embodiment, a server apparatus includes: a processor configured to perform: receiving a group ID and a plurality of calculation data corresponding to the group ID from a communication device; registering the plurality of received calculation data correlated with the received group ID; and transmitting image data acquired by aggregating the plurality of registered calculation data for the group ID.

### CROSS-REFERENCE TO RELATED APPLICATIONS

This application is based upon and claims the benefit of priority from Japanese Patent Applications No. 2014-239297, filed Nov. 26, 2014; No, 2014-191868, filed Sep. 19, 2014; and No. 2014-191879, filed Sep. 19, 2014, the entire contents of all of which are incorporated herein by reference.

### BACKGROUND OF THE INVENTION

1. Field of the Invention

The present invention relates to a server apparatus, a data collection method, and a communication device.

2. Description of the Related Art

Conventionally, information display devices called scientific calculators used for learning calculation processes of various functional equations are widely used.

As a use form of such information display devices, in Patent Document 1 (Japanese Patent No. 4720607), it has been proposed that, in a class of a school or the like for displaying and analyzing the graph of a functional equation, each student uses an information display device, and an information display device used by a teacher receives calculation target data such as graph data from the information display device of each student that is transmitted through infrared communication or the like, aggregates the received calculation target data, and projects and displays the aggregated calculation data as a result of the aggregation in an enlarged scale.

In addition, in recent years, calculation servers have been provided each accessed by a communication device such as a smartphone and providing a calculation service of a high-level function on the Internet.

In addition, as a technique for sharing same data among a plurality of information devices not having a communication function, in Patent Document 2 (Jpn. Pat. Appln. KOKAI Publication No. 2011-076540), it has been proposed that one device displays a QR code (registered trademark) corresponding to input text data, and the other device photographs the displayed QR code using a camera, converts the QR code into original text data, and displays the converted original text data.

In Patent Document 1 described above, while described that calculation target data is received from a plurality of information display devices, and summarized aggregated calculation data is output, it is necessary to associate the information display devices with each other to be communicably connected in advance.

In addition, by using the technology proposed in Patent Document 2 described above, while calculation target data received from the information display devices of students can be coded into a QR code and be aggregated together without requiring a communication function, the aggregated calculation target data of the students cannot be easily grouped and managed for each class or group to which each student belongs.

### BRIEF SUMMARY OF THE INVENTION

An object of the present invention is to provide a server apparatus, a data aggregation method, and a communication device capable of outputting calculation target data of each information display device as aggregation result data that is a resultant data aggregated for each group to which each information display device belongs.

A server apparatus according to the present invention includes: a processor configured to perform: receiving a group ID and a plurality of calculation data corresponding to the group ID from a communication device; registering the plurality of received calculation data correlated with the received group ID; and transmitting image data acquired by aggregating the plurality of registered calculation data for the group ID.

According to the present invention, calculation target data of each information display device can be output as aggregation result data that is resultant data aggregated for each group to which each information display device belongs.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are a schematic diagram that illustrates the use form of a calculation server relating to a server apparatus according to an embodiment of the present invention;

FIG. 2 is a block diagram that illustrates the configuration of the electronic circuit of a scientific calculator;

FIG. 3 is a block diagram that illustrates the configuration of the electronic circuit of a communication device used for a teacher;

FIG. 4 is a block diagram that illustrates the configuration of the electronic circuit of the calculation server;

FIG. 5 is a flowchart that illustrates the server process executed by the calculation server;

FIG. 6 is a flowchart that illustrates a received data aggregation process accompanied with the server process executed by the calculation server;

FIG. 7 is a flowchart that illustrates a display control process executed by the scientific calculator;

FIG. 8 is a flowchart that illustrates a QR photographing process executed by the communication device used for a teacher;

FIGS. 9A to 9E are diagrams that illustrate display operations of a communication device used for a teacher and the scientific calculator of a student in a case where the calculation server is used;

FIGS. 10A to 10D are diagrams that illustrate display operations of the communication device used for a teacher and the scientific calculator of a student in a case where the calculation server is used;

FIG. 11 is a diagram that illustrates a specific example of aggregated image data generated based on received data (registration data) of an individual class data area in the calculation server;

FIG. 12 is a diagram that illustrates seating table data according to another embodiment registered in the individual class data area of the calculation server;

FIG. 13 is a diagram that illustrates a graph data list screen corresponding to the seating table for each class generated according to the received data aggregation process executed by the calculation server; and

FIG. 14 is a diagram that illustrates a graph data list screen corresponding to a group table for each class generated according to the received data aggregation process executed by the calculation server.

### DETAILED DESCRIPTION OF THE INVENTION

Hereinafter, an embodiment of the present invention will be described with reference to the drawings.

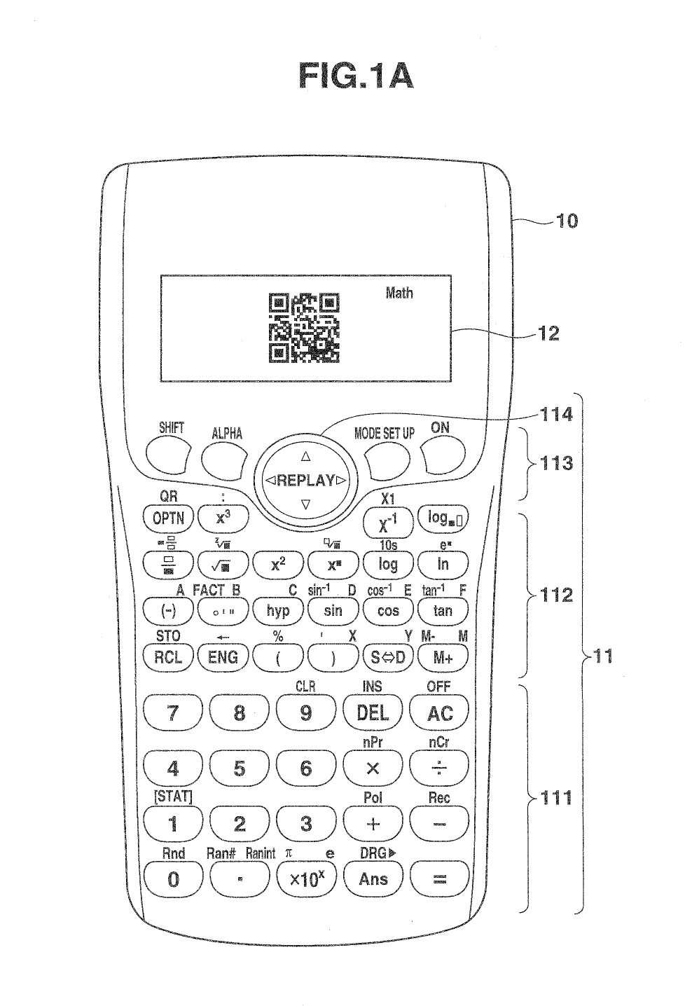

FIGS. 1 and 1B are a schematic diagram that illustrates the use form of a calculation server 30 relating to a server apparatus according to an embodiment of the present invention.

Here, as illustrated in FIGS. 1 and 1B, a system will be described as an example which is configured by a scientific calculator 10 as an information display device used by each student, communication devices 20 used for a teacher, a calculation server 30, and a projector P. The communication device 20 used for a teacher is a camera-attached tablet PC used by each teacher (for example, a main class teacher or a sub class teacher) photographing an image of a two-dimensional code such as a QR code (registered trademark) that is displayed and output from the scientific calculator 10 of each student or the like. The calculation server 30 relating to a server apparatus according to an embodiment of the present invention receives calculation target data transmitted from the communication device 20 used for a teacher through a communication network N such as the Internet according to data of the content of the photographed two-dimensional code. The calculation server 30 aggregates calculation target data transmitted from each scientific calculator 10 described above for each group to which each student described above belongs, thereby acquiring aggregated calculation result data that is a result of the calculation. The communication device 20 used for a teacher receives the aggregated calculation result data for each group, which is acquired by the calculation server 30, through the communication network N and displays and outputs the aggregated calculation result data. The projector P projects and displays the aggregated calculation result data that is displayed and output to the communication device 20 used for a teacher in an enlarged scale.

Here, the communication device 20 used for a teacher is not limited to the camera-attached tablet PC but may be configured as a camera-attached personal digital assistants (PDA), a camera-attached smartphone, a camera-attached or camera-connected notebook personal computer (PC), an electronic blackboard, or the like.

In FIGS. 1 and 1B, while two communication devices 20 used for teachers are illustrated, this is only for representing separate units so as to represent transitions of a display output device 21 that are at the time of photographing the two-dimensional code and at the time of receiving the calculation result data, and actually, one communication device 20 for a teacher is prepared for each of the main class teacher and the sub class teacher. In addition, while one scientific calculator 10 is representatively illustrated, actually, the number of scientific calculators 10 corresponding to the number of students. In addition, one scientific calculator 10 used for a teacher may be further prepared.

According to the need for the portability, the scientific calculator 10 has a small size that can be sufficiently held by a user using one hand and can be operated by using one hand, and a key input device 11 and a display output device 12 are arranged on the front face of the main body of the scientific calculator 10.

The key input device 11 includes: a numeric/operation symbol key group 111; a function key group 112; a mode setting key group 113; and a cursor key 114. The numeric/operation symbol key group 111 is a key group used for inputting a numerical value or a numerical expression and giving an instruction for the execution of calculation. The function key group 112 is a key group used for inputting various functions and starting up a memory function or the like. The mode setting key group 113 is a key group used for displaying a menu screen of various operation modes and giving an instruction for setting an operation mode. The cursor key 114 is a key used for executing an operation of moving a cursor displayed on the display output device 12, an operation of selecting a data item, or the like.

The numeric/operation symbol key group 111 includes [0] to [9] (numeric) keys, [+][−][×][/] (four rules of arithmetic) keys, [Ans][=] (execution) keys, an [AC] (clear) key, and the like.

The function key group 112 includes starting from an [x⁻¹] (“−1st” power: inverse) key, a [√] (root) key, a [□/□] (fraction) key, a [sin] (sine) key, a [M+] (memory plus) key, an [OPTN] (option) key, a [RCL] (memory call), key and the like.

The mode setting key group 113, includes a [MODE] (mode) key, a [SHIFT] (shift) key, an [ALPHA] (alphabet) key, an [ON] (power on) key, and the like.

In addition, by continuously operating a key of the numeric/operation symbol key group 111 and the function key group 112 key after the operation of the [SHIFT] key, the key can serve as not a key function described at the key top but a key described on the upper side of the key. For example, when the [AC] key is operated (hereinafter, described as a [SHIFT]+[AC] key) after the operation of the [SHIFT] key, the key serves as an [OFF] (power off) key. In addition, a [SHIFT]+[OPTN] key serves as a [QR] (QR) key, and a [SHIFT]+[RCL] key serves as an [STO] (memory registration) key.

The display output device 12 is configured by a liquid crystal display unit of a dot matrix type.

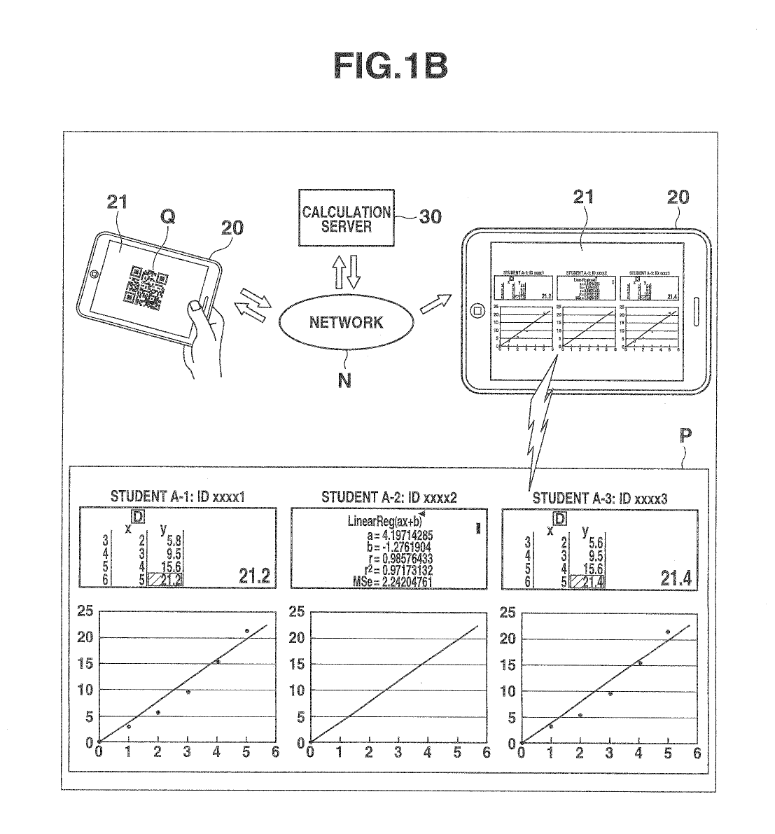

FIG. 2 is a block diagram that illustrates the configuration of the electronic circuit of the scientific calculator 10.

Here, one of scientific calculators 10A, 10B, . . . possessed by a plurality of students will be described as the scientific calculator 10.

In addition to the key input device 11 and the display output device 12, the electronic circuit of the scientific calculator 10 includes a CPU 13 that is a computer; a memory 14; and a recording medium reading device 15 that is a recording medium. In addition, as denoted by broken lines in the figure, the electronic circuit of the scientific calculator 10 may include a Wireless communication device 16.

The CPU 13 controls the operation of each device (circuit) in accordance with a numerical expression calculation processing program 141 stored in a memory 14 and executes various calculation processes according to a key input signal transmitted from the key input device 11. This numerical expression calculation processing program 141 may be stored in the memory 14 in advance or may be read from an external recording medium M such as a memory card through a recording medium reading device 15 into the memory 14 so as to be stored therein. This numerical expression calculation processing program 141 is configured not to be overwritten by a user's operation for the key input device 11.

In addition, as user non-rewritable information, a unique ID 142 is stored in the memory 14. This unique ID 142 is an ID that is unique to each of the scientific calculators 10A, 10B, . . . .

In the memory 14, in addition to such user non-rewritable information, an input data area 143 is secured for storing data that can be overwritten by the user.

Here, data input by the key input device 11 through keys is sequentially input to the input data area 143, and data of a numerical expression or table data configured by the data is stored in the input data area 143. In addition, a calculation function executed by the scientific calculator 10 and data representing the calculation type are stored in the input data area 143 as well.

In addition, the wireless communication device 16 has a function for executing wireless communication such as Bluetooth (registered trademark) or infrared communication with an external communication device 20 used for a teacher.

The scientific calculator 10 configured in this way realizes a display control function as described in an operation description to be presented as the CPU 13 controls the operation of each device (circuit) in accordance with a command described in the numerical expression calculation processing program 141 so as to cause software and hardware to operate in a cooperative manner.

Each of the communication devices 20a and 20b use for teachers photographs a two-dimensional code image (QR code) that is output to be displayed on the display output device 12 of the scientific calculator 10, adds a group ID (a unique class ID to a class to which the student belongs) and a mail address of the communication device to data of the content of the photographed two-dimensional code image (QR code), and transmits resultant data to the calculation server 30 of which the address is set in advance through the communication network N.

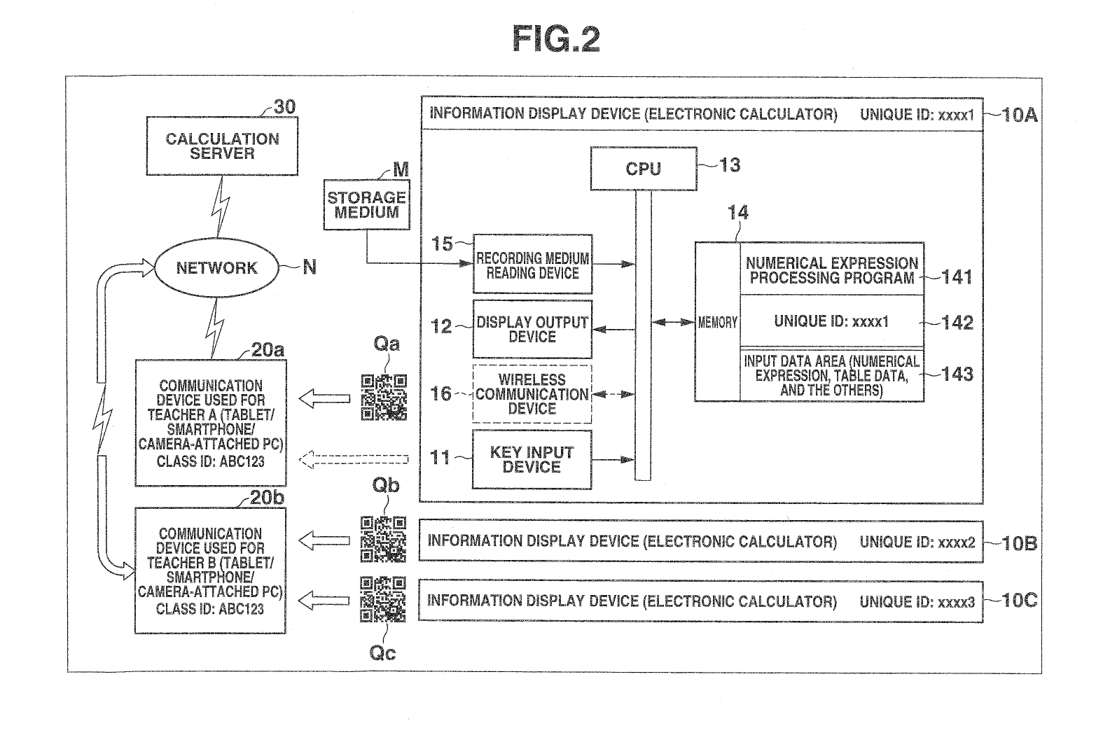

FIG. 3 is a block diagram that illustrates the configuration of the electronic circuit of the communication device 20 used for a teacher.

Here, one of the communication devices 20a and 20b used for teachers that are possessed by a plurality of teachers (for example, a main class teacher and a sub class teacher) will be described as the communication device 20 used for a teacher.

In addition to the display output device 21, the electronic circuit of the communication device 20 used for a teacher includes: a CPU 22 that is a computer; a memory 23; a recording medium reading device 24; a touch input device 25 overlapping the display output device 21 so as to be integrated therewith; a camera 26; and a wireless communication device 27. In addition, the touch input device 25 may include a key input device such as a power key.

The CPU 22 controls the operation of each device (circuit) according to a touch (or key) input signal transmitted from the touch input device 25 or a reception signal received by the wireless communication device 27 in accordance with a communication device control program 221 and a dedicated QR reading processing program 222 stored in the memory 23. Each of the programs 221 and 222 may be stored in the memory 23 in advance or may be read from an external recording medium M such as a memory card through the recording medium reading device 24 into the memory 23 so as to be stored therein.

In addition, in the memory 23, a device unique ID 223 is stored as user non-rewritable information. This device unique ID 223 is an ID that is unique to each of the communication devices 20a, 20b, . . . , used for teachers.

In addition to such information, in the memory 14, a mail address 224, a calculation server HP address 225, a teacher-specific access destination number 226, and a group ID (class ID) 227 are stored.

The mail address 224 is a mail address that is unique to the device, the calculation server HP address 225 is an HP address of the calculation server 30, the teacher-specific access destination number 226 is a mail address of the PC of the teacher who is the user of the device, and the group ID (class ID) 227 is a class ID that is arbitrarily set for each group, for example, each class by the teacher who is the user of the device.

In the communication device 20 for a teacher configured in this way, the CPU 22 controls the operation of each device (circuit) according to a command described in the communication device control program 221 or the dedicated QR reading processing program 222. By operating software and hardware in a cooperative manner, as will be described in an operation description to be presented later, the CPU 22 reads the two-dimensional code (the QR code in this embodiment) that is displayed on the scientific calculator 10, adds a group ID and a mail address of the communication device to data of the content of this two-dimensional code image (QR code), and transmits resultant data to the calculation server 30, thereby realizing the QR photographing/transmitting function.

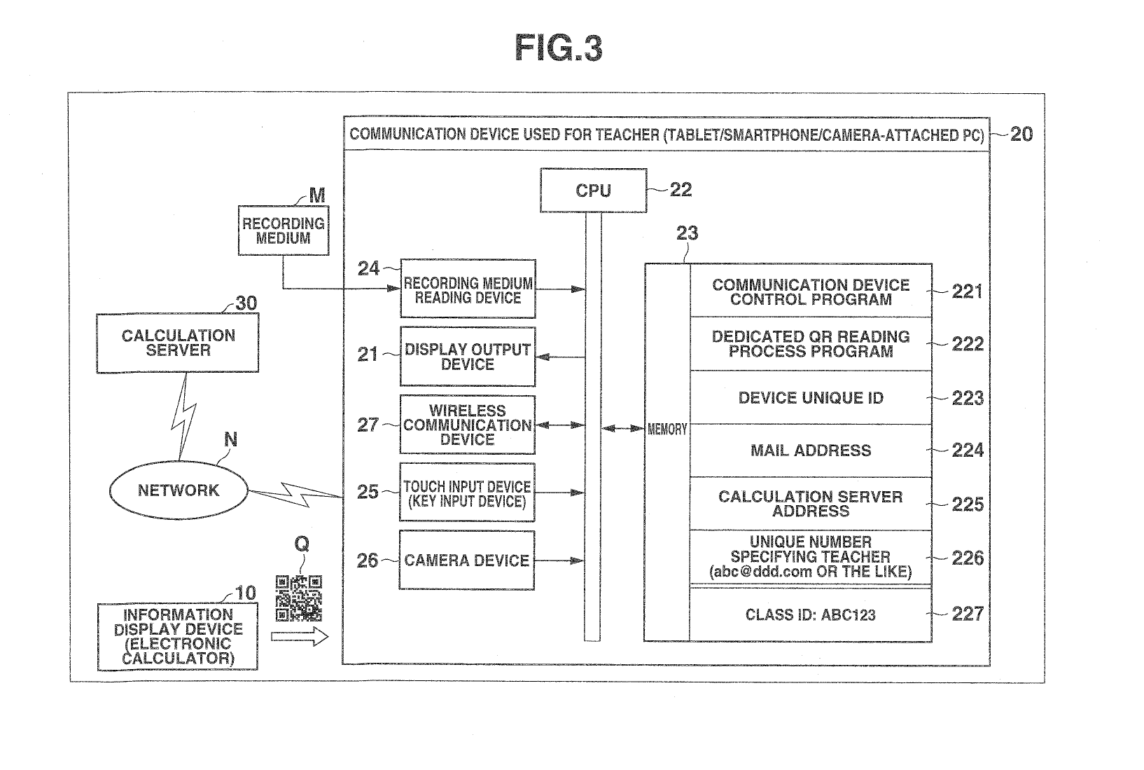

FIG. 4 is a block diagram that illustrates the configuration of the electronic circuit of the calculation server 30.

The electronic circuit of the calculation server 30 includes: a CPU 31 that is a computer; a memory 32; a recording medium 33; a recording medium reading device 34; and a communication device 35. In addition, as denoted by broken lines in the figure, a key input device 36 or a display output device 37 may be included in the electronic circuit of the calculation server 30.

The CPU 31 controls the operation of each device (circuit) according to a server control program 321 that is stored in the memory 32 in advance, is read into the memory 32 from the recording medium 33 such as a memory card through the recording medium reading device 34, or downloaded into the memory 32 from a web server not illustrated in the figure on the communication network N through the communication device 35. The CPU 31 executes various calculation processes according to barcode content data received from the communication device 20 used for a teacher that is received by the communication device 35.

In the memory 32, a registration data memory 322 and a group ID memory 323 are secured. The registration data memory 322 registers barcode content data received from the communication device 20 used for each teacher through the communication device 35 for each group ID, in addition to being stored in the server control program 321. The group ID memory 323 stores a plurality of group IDs in association with transmission destination information. Here, in the registration data memory 322, a dedicated data area 322A for each group ID is generated, and, therein, the barcode content data that is read and received from the scientific calculators 10A, 10B, . . . of the students by the communication device 20 used for a teacher can be registered as class data. In this embodiment, while the transmission destination information of the group ID memory 323 is the mail address of the communication device 20 used for a main class (sub class) teacher of each class, it may be an access destination number 226 by which the teacher can be specified or the like. The transmission destination information and the group ID are set according to an access from the communication device 20 used for a teacher in advance, and the registration data memory 322 for the group ID and the group ID memory 323 are secured in accordance with the setting thereof.

In addition, the server control program 321 has a function for executing a setting operation or a maintenance operation in accordance with a setting operation, a maintenance operation, or the like of the key input device 36 that is executed by an operator of the calculation server 30, a function for displaying the development process or the result of the operation on the display output device 37, and the like.

The calculation server 30 configured in this way realizes a server processing function as presented in the following operation description as the CPU 31 operates software and hardware in a cooperative manner by controlling the operation of each device (circuit) in accordance with a command described in the server control program 321.

The communication device 20 used for a teacher can display, on the display output device 21, the aggregated calculation data or the calculation result data received from the calculation server 30 through the communication network N and execute projection display of the data in an enlarged scale by connecting the projector P to the communication device 20 used for a teacher.

Next, the server processing function of the calculation server 30 having the above-described configuration will be described.

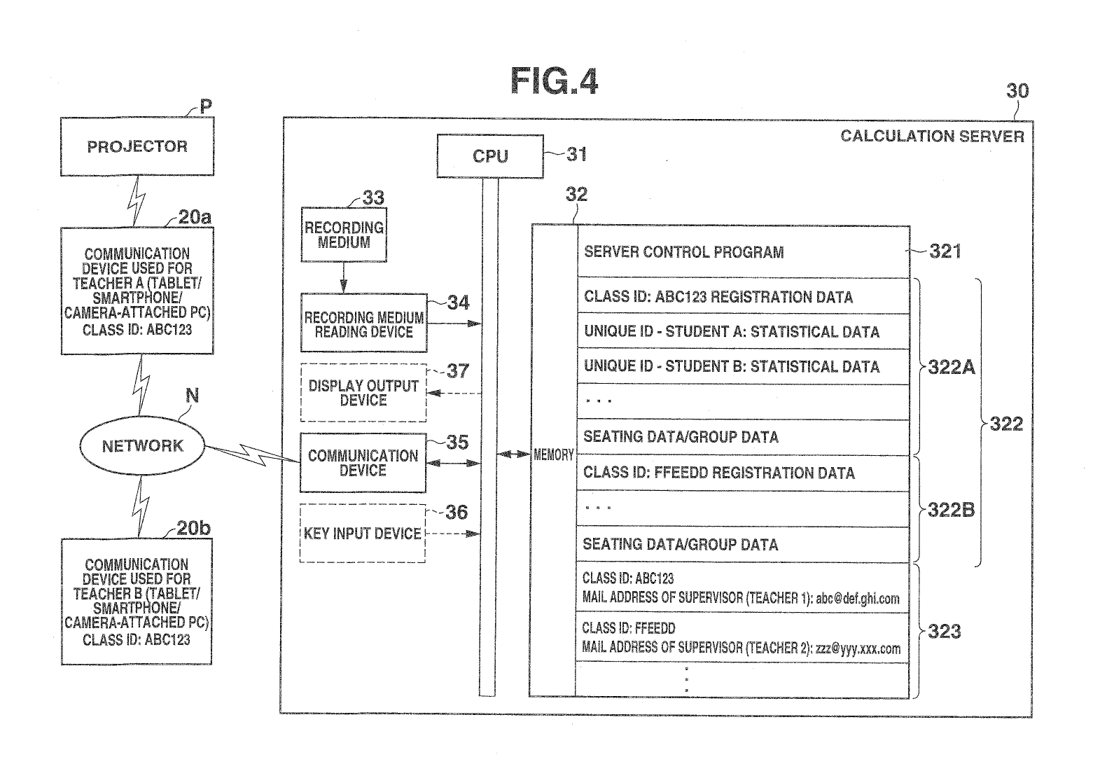

FIG. 5 is a flowchart that illustrates the server process executed by the calculation server 30.

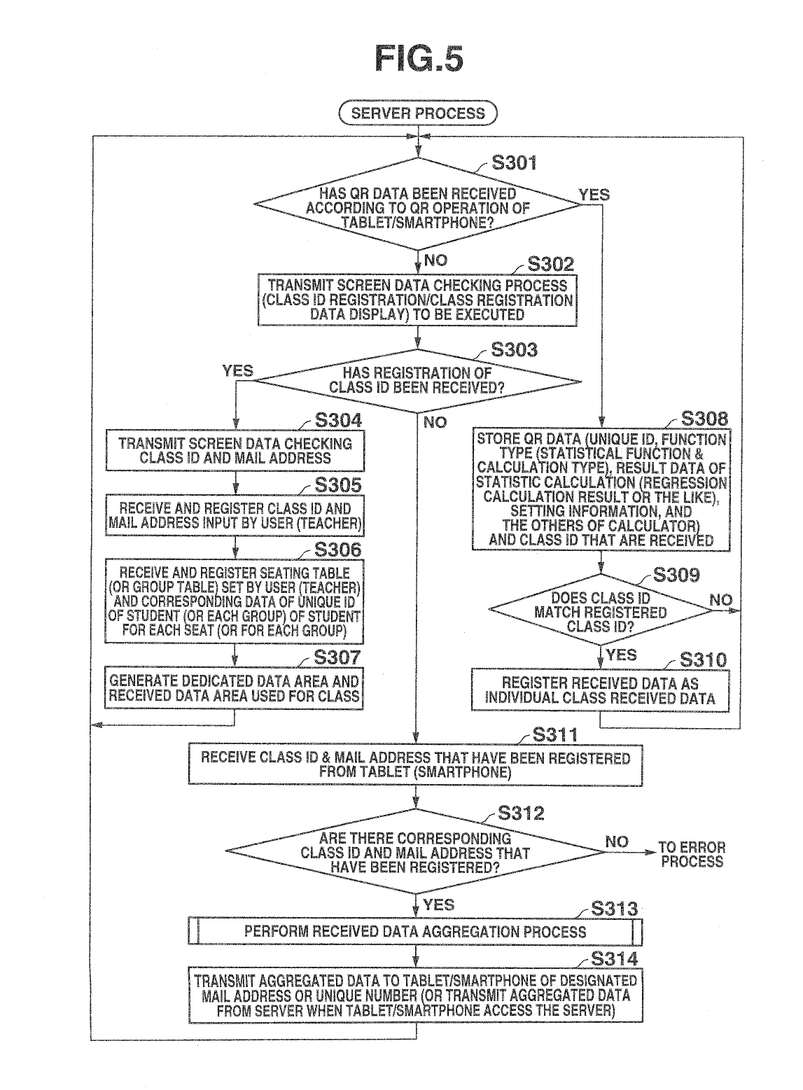

FIG. 6 is a flowchart that illustrates a received data aggregation process accompanied with the server process executed by the calculation server 30.

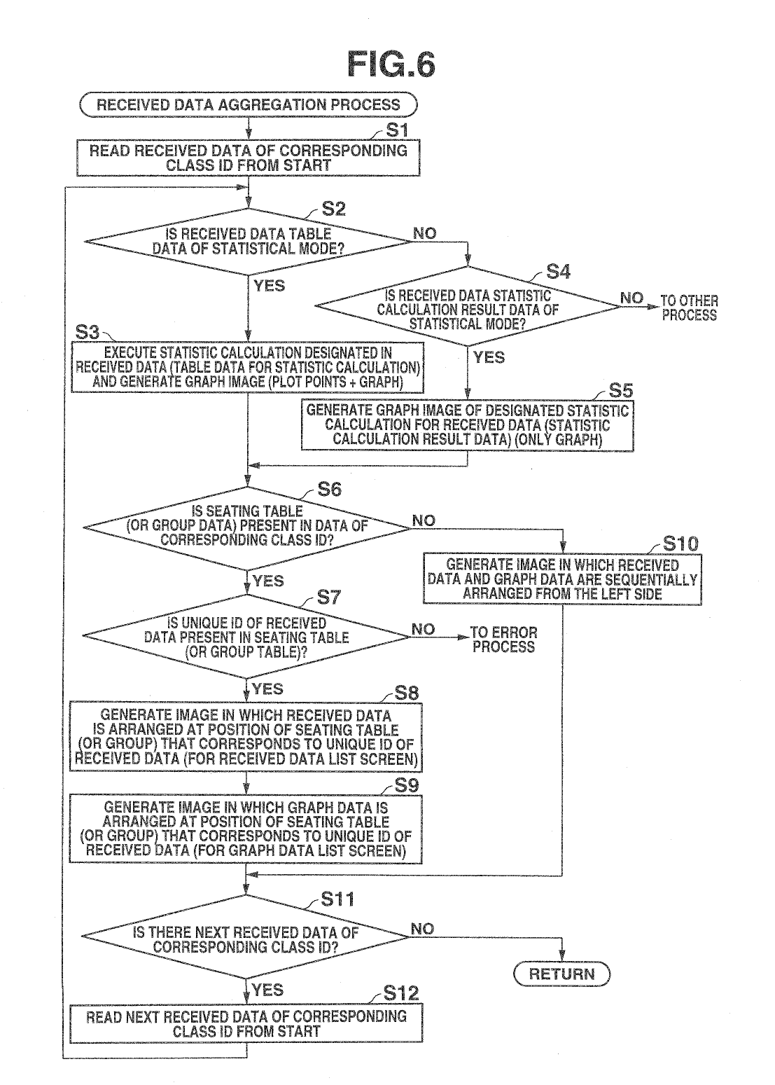

FIG. 7 is a flowchart that illustrates a display control process executed by the scientific calculator 10.

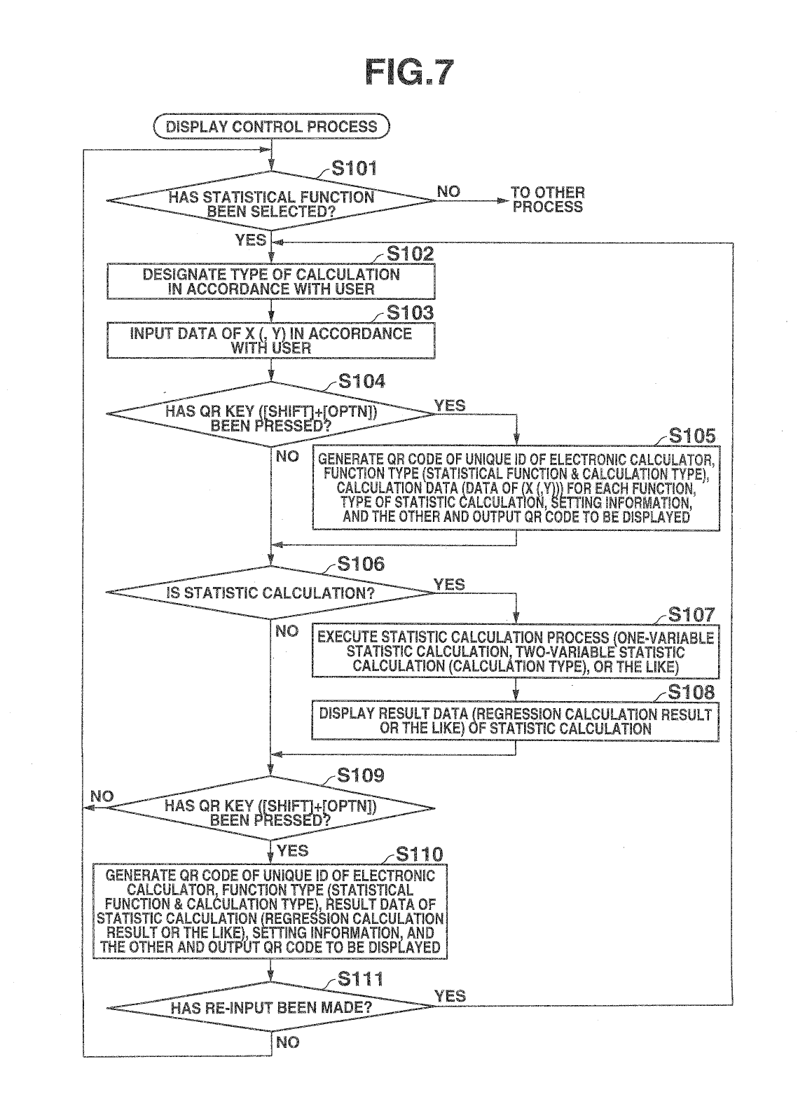

FIG. 8 is a flowchart that illustrates a QR photographing process executed by the communication device 20 used for a teacher.

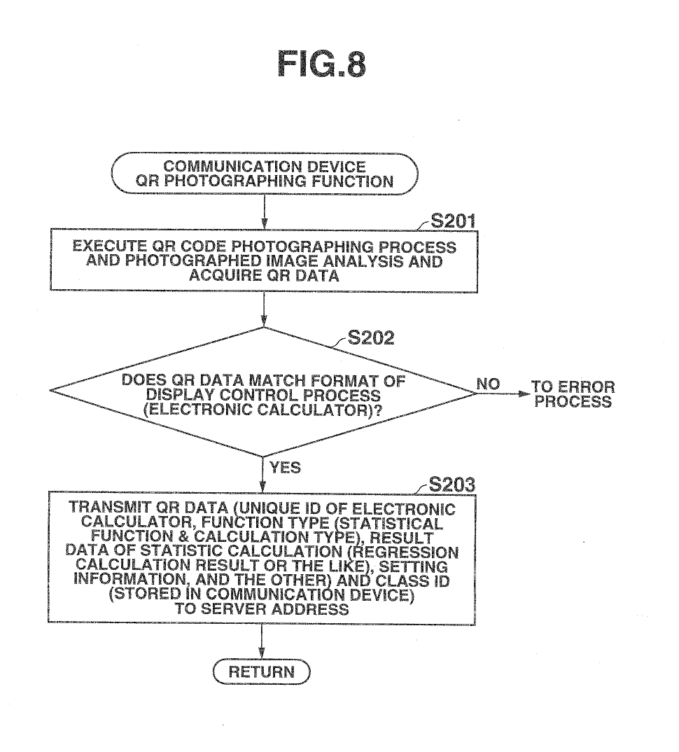

FIGS. 9A to 9E are diagrams that illustrate display operations of the communication device 20 used for a teacher and the scientific calculator 10 of a student A in a case where the calculation server 30 is used.

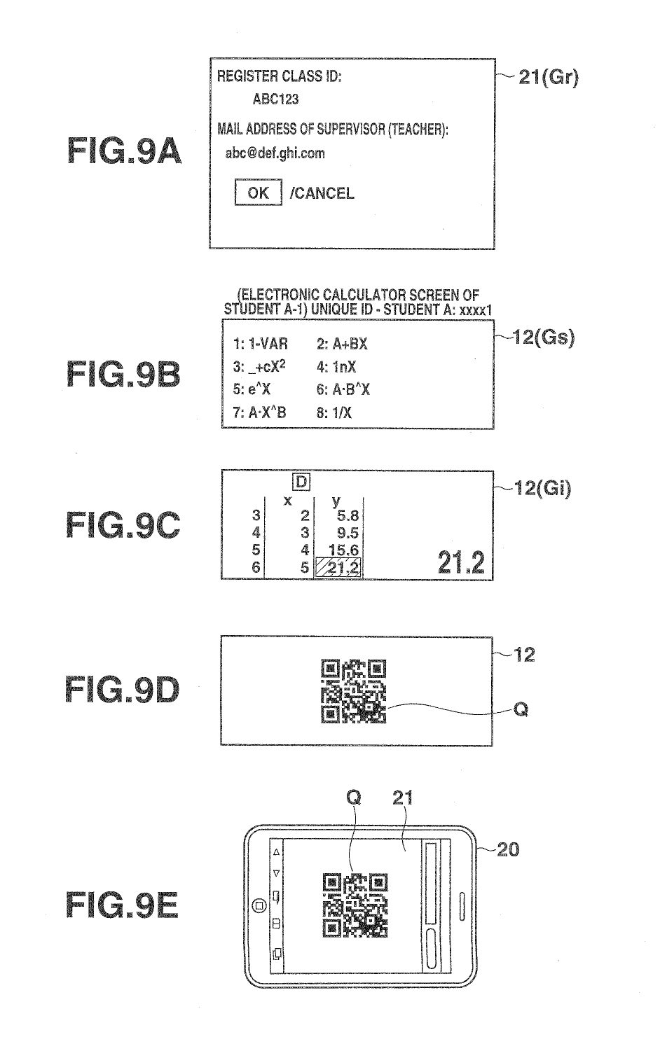

FIGS. 10A to 10D are diagrams that illustrate display operations of the communication device 20 used for a teacher and the scientific calculator 10 of a student B in a case where the calculation server 30 is used

First, when there is reception in the communication device 35 from the communication device 20 (a camera-attached tablet PC or a camera-attached smartphone) used for a teacher through the communication network N, the CPU 31 of the calculation server 30 determines whether the reception is reception of the barcode content data according to a QR operation in the tablet PC (Step S301).

Here, in a case where the reception is determined not to be the reception of the barcode content data according to the QR operation, the CPU 31 transmits screen data checking a process (class ID registration/class registration data display) desired to be executed by the teacher to the tablet PC that is a transmission source through the communication network N by using the communication device 35 (Step S302). For example, when the communication device 20 used for a teacher opens a link of a home page of the calculation server 30 by accessing the calculation server 30 or accesses the calculation server 30 from a dedicated application, the calculation server 30 determines that the reception is not the reception of the barcode content data according to the QR operation and transmits screen data checking a process desired to be executed. Accordingly, the checking screen is output to be displayed on the display output device 21 of the communication device 20 used for a teacher, and the teacher who is a user selects a process desired to be executed.

The CPU 31 determines whether or not the “registration of a class ID” has been received in accordance with the teacher's selection (Step S303). Here, in a case where it is determined that the “registration of a class ID” has been received, the CPU 31 transmits screen data checking a class ID (group ID) and a mail address to the communication device 20 used for a teacher by using the communication device 35 (Step S304). In the communication device 20 used for a teacher that has received the screen data, a screen checking a class ID (group ID) and a mail address displayed on the display output device 21. Then, as illustrated in FIG. 9A, the teacher inputs a class ID (group ID) of a class in charge and a mail address of the tablet PC and selects “[OK]”, and accordingly, the CPU 31 receives the class ID and the mail address input by the user (teacher) through the communication network N by using the communication device 35. Then, the CPU 31 registers the class ID and the mail address in the group ID memory 323 of the memory 32 in association with each other (Step S305).

Next, in a case data of a seating table (or a group table) of a class in charge that is input by the user (teacher) and data corresponding to a unique ID of a student (scientific calculator 10) for each seat (or each group) are received, the CPU 31 registers the data in the registration data memory 322 of the memory 32 in association with the corresponding class ID (Step S306).

Then, an individual class data area 322A, which is dedicated for the class, is generated in the registration data memory 322 of the memory 32 (Step S307). Thereafter, the CPU 31 is returned to the process of Step S301.

In this way, in association with the class ID (group ID) of the class of which the teacher is in charge, the mail address of the teacher is registered in the group ID memory 323 of the calculation server 30. In addition, for each class (322A, . . . ), data of the seating table (or the group table) correlated with the unique ID of the student (scientific calculator 10) is registered in the registration data memory 322 for each seat (or each group).

Before the server process is continued to be described, the display control function of the scientific calculator 10 will be described with reference to the flowchart represented in FIG. 7.

The scientific calculator 10A used by a student A belonging to a class ID (group ID) of “ABC123” will be described as an example. The CPU 13, first, determines whether a statistical function is selected from among various functions of the scientific calculator (Step S101). In other words, it is determined whether or not a statistical function is selected from among various functions represented by a list table in accordance with the operation of the [MODE] key: Here, in a case where a function other than the statistical function is determined to be selected, the CPU 13 causes the process to proceed to the other process.

On the other hand, in a case where the statistical function is determined to be selected, the CPU 13, as illustrated in FIG. 9B, displays a statistical mode selection screen Gs on the display output device 12 and receives the designation of a calculation type according to a user's operation (Step S102). On the statistical mode selection screen Gs, items of one-variable statistics/two-variable statistics: linear regression/logarithmic regression/e logarithmic regression/ab exponential regression/exponential regression/inverse regression/secondary regression are represented in a list table, and designation of a calculation type from among such calculation types is made. Then, the CPU 13 receives an input of calculation target data X (and Y) relating to the designated calculation type (Step S103).

Here, a case will be described in which “2” (two-variable statistics: linear regression) is designated on the statistical mode selection screen Gs, and, as illustrated in FIG. 9C, data of a table of two variables X and Y is selected on a table data input screen Gi. The input table data X and Y is registered in the input data area 143 of the memory 14.

Thereafter, the CPU 13 determines whether or not the “QR” key, in other words [SHIFT]+[OPTN] keys of the key input device 11 have been pressed (Step S104). Here, in a case where it is determined that the “QR” key has not been pressed, the process proceeds to the process of Step S106 to be described later.

On the other hand, in a case where the [QR] key is determined to have been pressed, the CPU 13 generates a two-dimensional code image (QR code) of the unique ID of the scientific calculator 10A that is stored in the unique ID 142 of the memory 14, the functional type (here, a statistical function and a calculation type) of an execution function stored in the input data area 143, calculation target data (table data X and Y and the type (two variable statistics: linear regression) of the statistic calculation) for each function, setting information, and the others and, as illustrated in FIG. 9D, outputs the generated two-dimensional code image (QR code) Q to the display output device 12 to be displayed thereon (Step S105).

Here, the setting information includes setting information of various modes such as an angle mode, a rounding mode, and a display mode.

On the other hand, in a case where it is determined that an instruction of the statistic calculation process is given, the CPU 13 executes the statistic calculation process, in other words, the one-variable statistic calculation, the two-variable statistic calculation, or the like by using data registered in the input data area 143 as the type designated by the user operation (Step S107). Then, result data of the statistic calculation is output to be displayed on the display output device 12 (Step S108).

Next, the display control function of the scientific calculator 10 will be described with reference to a scientific calculator 10B of a student B belonging to the same class as that of the student A as an example. On the statistical mode selection screen Gs of the scientific calculator 10B, a calculation type “2” (two-variable statistics: linear regression) is designated, and, as illustrated in FIG. 10A, table data of two variables X and Y is input on a table data input screen Gi (Steps S102 and S103).

Then, when an instruction for the statistic calculation process is given (Step S106), based on the input table data X and Y, the CPU 13 executes statistic calculation (two variable statistic calculation: linear regression) (Step S107) and, as illustrated in FIG. 10B, outputs result data of the statistic calculation to the display output device 12 to be displayed thereon as a calculation result screen Gcl (Step S108).

Thereafter, in a case where the CPU 13 determines that the [QR] key of the key input device 11, in other words, the [SHIFT]+[OPTN] keys have been pressed (Step S109), the CPU 13 generates a two-dimensional code image (QR code) of the unique ID of the scientific calculator 10B that is stored in the unique ID 142 of the memory 14, the functional type (here, the statistical function and the calculation type) of the execution function that is stored in the input data area 143, calculation result data, setting information, and the others. Then, the CPU 13, as illustrated in FIG. 10C, outputs the two-dimensional code image (QR code) Q to the display output device 12 to be displayed thereon (Step S110).

Thereafter, the CPU 13 determines whether or not there is a re-input of data (Step S111). Here, in a case where it is determined that there is no re-input, the CPU 13 returns the process to the process of Step S101. On the other hand, in a case where it is determined that there is a re-inputting, the CPU 13 returns the process to the process of Step S102.

In this way, corresponding two-dimensional code images (QR code) Q are displayed on the display output device 12 by the display control processes executed by the scientific calculators 10A, 10B, . . . of the students A, B, . . . .

Next, the QR photographing/transmitting function of the communication device (tablet PC) 20 used for a teacher will be described with reference to the flowchart of the QR photographing process illustrated in FIG. 8.

As illustrated in FIGS. 9E and 10D, when the image of the two-dimensional code image (QR code) Q is photographed by the communication device 20 used for a teacher, the CPU 22 analyzes barcode content data that is the content of the two-dimensional code image (QR code), thereby acquiring the barcode content data (Step S201).

Then, the CPU 22 determines whether or not the acquired barcode content data matches the format of barcode content data according to the display control process executed by the scientific calculator 10 (Step S202).

In a case where it is determined that the acquired barcode content data matches the format of the barcode content data according to the scientific calculator 10, the CPU 22 transmits the analyzed barcode content data and the group ID (class ID) 227 of the class in charge that is stored in the memory 23 to the calculation server 30 through the communication network N (Step S203). Thus, the HP address 225 of the calculation server 30 for transmission is known to the teacher in advance, and the teacher inputs the HP address 225 by operating his/her communication device 20 used for a teacher, thereby registering the HP address 225 in the memory 23.

Here, in the case of the two-dimensional code image (QR code) Q photographed from the scientific calculator 10A of the student A, the barcode content data is the unique ID of the scientific calculator 10A, the function type (the statistical function and the calculation type), the calculation target data (table data X and Y and the type (two-variable statistics: linear regression) of the statistic calculation) for each function, the setting information, and the other data. On the other hand, in the case of the two-dimensional code image (QR code) Q photographed from the scientific calculator 10B of the student B, the barcode content data is the unique ID of the scientific calculator 10B, the function type (the statistical function and the calculation type), calculation result data, the setting information, and the other data.

Here, the description will be returned to the operation of the calculation server 30.

When the barcode content data transmitted from the communication device 20 used for a teacher through the communication network N as described above is received by the communication device 35 of the calculation server 30, in Step S301, the CPU 31 of the calculation server 30 determines reception of the barcode content data according to a QR operation. In such a case, the CPU 31 stores the received barcode content data, in other words, in the case of the scientific calculator 10A, the unique ID: xxxx1 of the scientific calculator 10A, the class ID: ABC123 to which the student A belongs, the function type (the statistical function and the calculation type), the calculation target data (the table data X and Y and the type (the two-variable statistics: linear regression) of the statistic calculation) for each function, the setting information, and the others in the work area (not illustrated in the figure) used for the storage of received data that is arranged in the memory 32 (Step S308). In addition, the CPU 31, in the case of the scientific calculator 10B, stores the unique ID: xxxx2 of the scientific calculator 10B, the class ID: ABC123 to which the student B belongs, the function type (the statistical function and the calculation type), the calculation result data, the setting information, and the others in the work area (not illustrated in the figure) used for the storage of received data that is arranged in the memory 32 (Step S308).

Thereafter, the class ID included in the stored barcode content data is checked, and it is determined whether the class ID matches the class ID that has been registered in the group ID memory 323 (Step S309). Here, in a case where the class ID is determined not to match the class ID that has been registered, the CPU 31 returns the process to the process of Step S301.

On the other hand, in a case where the class ID (group ID) included in the stored barcode content data is determined to match the class ID that has been registered, the CPU 31 registers the stored barcode content data in the individual class data area 322A, which corresponds to the class ID that has been registered, of the registration data memory 322 as class data (Step S310).

In this way, in the individual class data area 322A corresponding to the class ID: ABC123 that has been registered, together with the data of the seating table (or the group table) of the corresponding class registered by the communication device (tablet PC) 20 used for a teacher, the unique ID and the statistical data (calculation target data) of the student A and the unique ID and the statistical data (calculation result data) of the student B are registered.

Thereafter, when the teacher accesses the calculation server 30 by using the communication device 20 used for a teacher and selects “class registration data display” as a process desired to be executed, the CPU 31 of the calculation server 30 determines no “registration of the class ID” in Step S303 (Steps S301 to S303: No).

Then, the CPU 31 receives the group ID (class ID) 227, which has been registered in the communication device 20, and the mail address 224 that are automatically transmitted from the communication device 20 for a teacher (Step S311).

Then, the CPU 31 determines whether or not the group ID (class ID) 227 and the mail address 224 received from the communication device 20 used for a teacher are the class ID and the mail address of the teacher that have been registered in the group ID memory 323 (Step S312).

Then, in a case where the group ID (class ID) 227 and the mail address 224 received from the communication device 20 used for a teacher are determined to be the class ID and the mail address that have been registered, the process proceeds to the received data aggregation process represented in FIG. 6 (Step S313).

In this received data aggregation process, the CPU 31 reads the statistical data correlated with the unique ID: xxxx1 of the student A that is the first received data that has been registered from the individual class data area 322A corresponding to the registered group ID (class ID: ABC123) received from the communication device 20 used for a teacher (Step S1) and determines whether or not the received data (statistical data) is table data of the statistical mode (Step S2).

Here, in a case where the received data (statistical data) correlated with the unique ID: xxxx1 of the student A is determined to be table data of the statistical mode, for the table data (see FIG. 9C) used for statistic calculation, statistic calculation (two-variable statistics: linear regression) designated by the calculation target data (table data X and Y and the type of statistic calculation) for each function is executed, and a graph image formed by plot points of the table data X and Y and a graph of linear regression is generated (Step S3).

Then, it is determined whether or not a seating table (or the group table) is registered in the individual class data area 322A corresponding to the group ID (class ID: ABC123) that has been registered (Step S6).

Here, first, a case will be described in which a seating table (or a group table) is not registered.

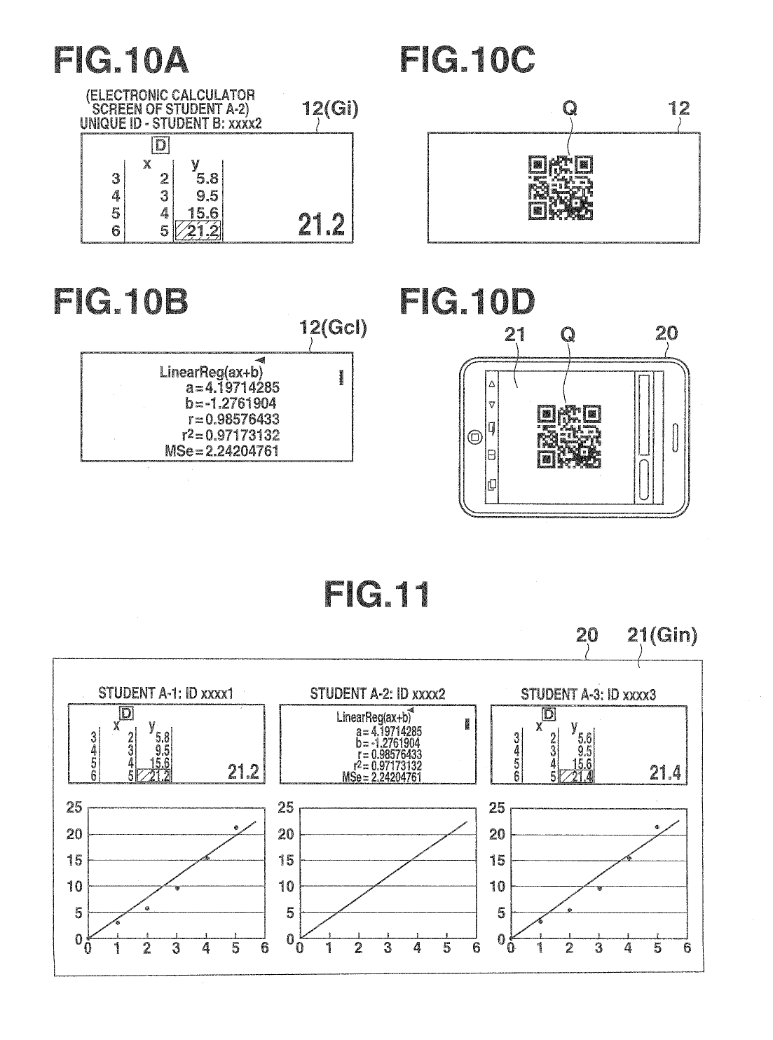

In a case where a seating table (or a group table) is not registered, aggregated image data (see FIG. 11) is generated in which the received data (statistical data: table data) of the student A and data of a graph image generated based on the statistical data are vertically aligned, and the aligned data is sequentially arranged from the left side (Step S10).

Thereafter, in a case where the next received data is determined to be present in the individual class data area 322A corresponding to the group ID (class ID: ABC123) (Step S11), the CPU 31 reads statistical data correlated with the unique ID: xxxx2 of the student B corresponding to the group ID (class ID: ABC123) (Step S12).

In a case where the statistical data of the student B is determined to be calculation result data of the statistics mode (Step S4), for the calculation result data (see FIG. 10B), statistic calculation (two-variable statistics: linear regression) designated by the function type is executed, and a graph image formed only by a graph of linear regression of the calculation result data is generated (Step S5).

Then, aggregated image data (see FIG. 11) is generated in which the received data (statistical data: calculation result data) of the student B and data of a graph image generated based on the statistical data are vertically aligned, and the aligned data is sequentially arranged from the left side (Step S10).

FIG. 11 is a diagram that illustrates a specific example of the aggregated image data generated based on the received data (registration data) of the individual class data area 322A in the calculation server 30.

In this aggregated image data, in order from the left side, the received data (table data) correlated with the unique ID: xxxx1 of the student A and the graph (plot points+graph) thereof, received data (calculation result data) correlated with the unique ID: xxxx2 of the student B and the graph (only the graph) thereof are arranged. In addition, similarly, according to the operation of reading the next received data (registration data), received data (table data) correlated with the unique ID: xxxx3 of the student C and the graph (plot points and a graph) thereof are arranged.

The data of the aggregated images for classes that are generated by the received data aggregation process is transmitted to the mail address of the communication device 20 used for a teacher that is correlated with the group ID (class ID: ABC123) registered in the group ID memory 323 as a destination (Step S314).

In addition, while the transmission (Step S314) of data of the aggregated images for each class from the calculation server 30 to the communication device 20 used for a teacher is configured to be executed in a case where the display of the class registration data is selected in the communication device 20 used for a teacher (Step S302), the data of the aggregated images for the class corresponding to the group ID (class ID) received from the communication device 20 used for a teacher may be configured to be transmitted to the communication device 20 used for a teacher that is an access destination when the home page HP of the calculation server 30 is accessed from the communication device 20 used for a teacher.

Accordingly, on the display output device 21 such as a camera-attached tablet PC that is a communication device 20 used for a main class teacher or a sub class teacher, as illustrated in FIG. 11, the statistical data (the table data or the statistic calculation result data) acquired from the scientific calculators 10A, 10B, . . . of students of the class in charge and data of aggregated images aggregating the graphs thereof are displayed as an aggregated image screen Gin. Then, as illustrated in FIG. 1, by projecting and displaying the aggregated image screen Gin in an enlarged scale by using the projector P, all the students of the corresponding class can learn while checking mutual statistical data.

Next, in the received data aggregation process (see FIG. 6) executed by the calculation server 30, a case will be described in which a seating table (or a group table) is registered in the individual class data area 322A of the calculation server 30.

In a case where the CPU 31 of the calculation server 30 determines that a seating table (or a group table) of a corresponding class is registered in the individual class data area 322A corresponding to the group ID (class ID: C123) received from the communication device 20 used for a teacher (Step S6), it is determined whether or not the unique ID of the student A (the scientific calculator 10A) included in the received barcode content data is registered in association with a seat (or a group) of the seating table (or the group table) (Step S7).

Here, in a case where the CPU 31 determines that the unique ID of the student A (the scientific calculator 10A) included in the received barcode content data is registered in association with a seat (or a group) of the seating table (or the group table) registered in the individual class data area 322A, data of aggregated images in which the received statistical data (the table data or the statistic calculation result data) is arranged at the position of a corresponding seat (or group) of the seating table (or the group table) as the received data list screen (Step S8).

In addition, data of aggregated images in which graphs of the received statistical data (the table data or the statistic calculation result data) are arranged at the positions of corresponding seats (or groups) of the seating table (or the group table) is generated as a graph data list screen (Step S9).

Thereafter, in a case where next received data is determined to be present in the individual class data area 322A corresponding to the group ID (class ID: ABC123) (Step S11), the CPU 31 reads the statistical data correlated with the unique ID: xxxx2 of the next student B corresponding to the group ID (class ID: ABC123) and causes the process to be returned to Step S2 described above (Step S12).

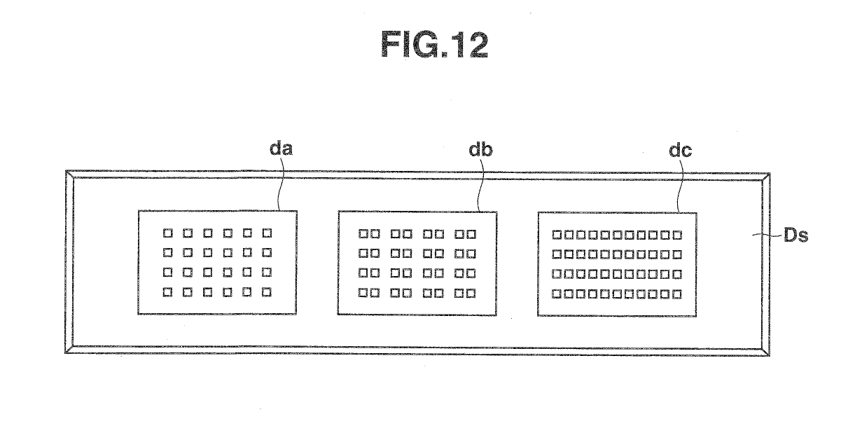

FIG. 12 is a diagram that illustrates seating table data Ds according to another embodiment registered in the individual class data area 322A of the calculation server 30.

In Step S306 of the server process described above, the data of the seating table registered in the individual class data area 322A of the calculation server 30 in accordance with a setting made using the communication device 20 used for a teacher may be registered as seating tables da, db, and dc of a plurality of patterns set in advance in accordance with the number of students of the corresponding class and a change in the arrangement of the seats.

In such a case, in the received data aggregation process S313 accompanied in the server process, after the arrangement of the seating table of a corresponding class is selected in accordance with the current arrangement, a received data list screen or a graph data list screen corresponding to the statistical data received as the barcode content data can be generated.

In the received data aggregation process, the received data list screen and the graph data list screen generated according to the seating table (or the group table) registered in the individual class data area 322A are transmitted to the mail address of the communication device 20 used for a teacher that is correlated with the corresponding group ID (class ID: ABC123) registered in the group ID memory 323 as the destination (Step S314).

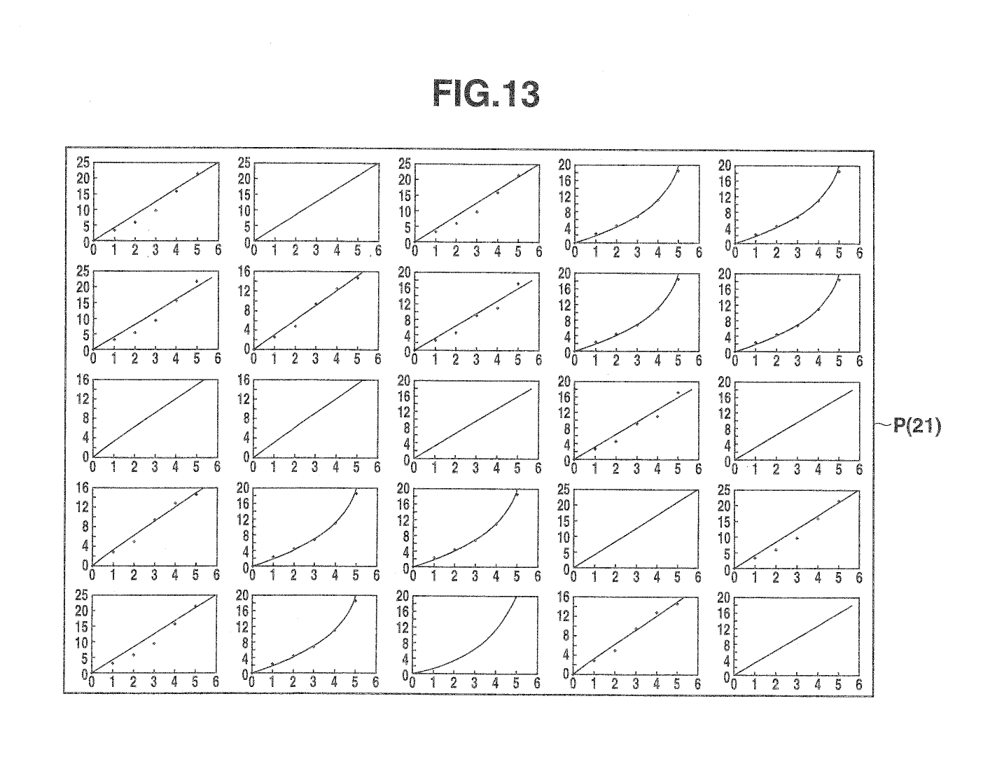

FIG. 13 is a diagram that illustrates a graph data list screen corresponding to the seating table for each class generated according to the received data aggregation process executed by the calculation server 30.

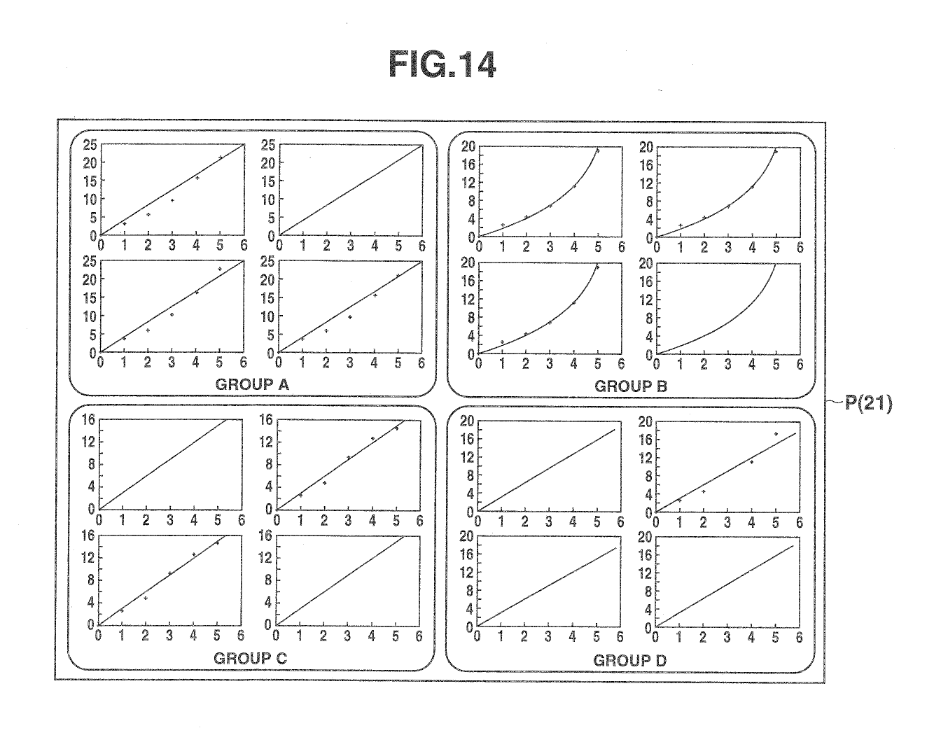

FIG. 14 is a diagram that illustrates a graph data list screen corresponding to a group table for each class generated according to the received data aggregation process executed by the calculation server 30.

Accordingly, on the display output device 21 such as a camera-attached tablet PC that is a communication device 20 used for a main class teacher or a sub class teacher, as illustrated in FIG. 13 (or FIG. 14), data of aggregated images in which graphs of statistical data (statistic calculation result data) acquired from the scientific calculators 10A, 10B, . . . of students of the class in charge are aggregated according to the seating table (or the group table) of the corresponding class is displayed. Then, by projecting and displaying the aggregated image screen in an enlarged scale by using the projector P, all the students of the corresponding class can learn while checking mutual statistical data.

In the embodiment described above, the calculation data is aggregated in the server for each group ID for each unique ID of the information display device (calculator) of each student. In such a case, when the calculation data of the same unique ID is corrected and is acquired by the server, the calculation data of the unique ID is updated and registered. In contrast to this, also for the same unique ID, the calculation data may be configured to be separately stored and aggregated based on the date and time. In addition, among data aggregated for a group ID, latest calculation data of a unique ID may be set as an aggregation target and is aggregated. In such a case, old calculation data can be prevented from being aggregated. Furthermore, a teacher managing the group ID may initialize the aggregated data within a group ID and set to remove data other than latest calculation data of each unique ID or to cause all the data to remain. In addition, it may be configured such that the aggregated data of a group ID is classified for each type of statistic calculation, and only the calculation data of a type designated by the teacher is collected.

In addition, any of the technique of each process executed by the calculation server 30 described in each embodiment described above, in other words, each technique of the server process illustrated in the flowchart represented in FIG. 5 and the received data aggregation process accompanied in the server process illustrated in the flowchart represented in FIG. 6, and the like may be distributed with being stored in a recording medium 33 such as a memory card (a ROM card, a RAM card, or the like), a magnetic disk (a floppy (registered trademark) disk, a hard disk, or the like), an optical disk (a CD-ROM, a DVD, or the like), a semiconductor memory as a program executable by a computer. In addition, data of a program used for realizing each technique described above may be transmitted on the communication network N in the form of a program code, and, by acquiring this program data by using a communication device 35 in a computer of an electronic apparatus that is connected to the communication network N, the server function described above can be realized.

The present invention is not limited to each embodiment described above but may be variously modified in a range not departing from the concept in an execution stage. In addition, in each embodiment described above, inventions of various steps are included, and various inventions can be extracted according to an appropriate combination of a plurality of disclosed constituent elements. For example, in a case where the object described above can be solved, and the advantages described above can be acquired also when some constituent elements are eliminated from all the constituent elements represented in each embodiment, or when some constituent elements are combined in a different form, a configuration in which such constituent elements are eliminated or combined can be extracted as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A server apparatus comprising:
a processor configured to perform:
receiving a group ID and a plurality of calculation data corresponding to the group ID from a communication device;
registering the plurality of received calculation data correlated with the received group ID; and
transmitting image data acquired by aggregating the plurality of registered calculation data for the group ID.

2. The server apparatus according to claim 1, further comprising:
a group ID storage device that stores (i) a plurality of group IDs including the group ID and (ii) a plurality of items of transmission destination information correlated with the respective ones of the plurality of group IDs,
wherein the processor is configured to perform transmitting a plurality of image data aggregated for the respective ones of the plurality of the group IDs to the respective ones of the plurality of items of transmission destination information.

3. The server apparatus according to claim 2, wherein the processor is configured to further perform:
registering each of the plurality of the group IDs and each of the plurality of items of the transmission destination information correlated with the respective ones of the plurality of group IDs in the group ID storage device in accordance with a user operation.

4. The server apparatus according to claim 1,
wherein the processor is configured to further perform:
receiving seating data and individual device IDs of information display devices together with the group ID and registering a seating table in which the individual device IDs of the information display devices are correlated with respective seats, and
wherein the processor is configured to perform:
transmitting the image data acquired by arranging the plurality of calculation data at positions of seats of the respective individual devices ID of the registered seating table.

5. The server apparatus according to claim 1,
wherein a unit of the plurality of calculation data is one of table data of statistic calculation and calculation result data of the table data, and
wherein the processor is configured to perform:
generating a graph image configured by plot points of the table data and a graph corresponding to the plot points in a case in which the unit of the plurality of calculation data is the table data of the statistic calculation and generating a graph image configured by a graph corresponding to the plurality of calculation result data in a case in which the unit of the plurality of calculation data is the calculation result data of the statistic calculation and transmitting the graph image as the image data aggregated for the group ID.

6. The server apparatus according to claim 1,
wherein the communication device acquires the plurality of calculation data from information display devices by imaging a plurality of two-dimensional code images displayed on respective display units of the information display devices, the two-dimensional code images generated based on the plurality of calculation data and
the receiving of the plurality of calculation data from the communication device includes the receiving of two-dimensional code data of the two-dimensional code images displayed by the respective information display devices and the group ID correlated with the plurality of calculation data corresponding to the respective two-dimensional code images.

7. The server apparatus according to claim 2,
each of the plurality of items of transmission destination information correlated with the respective ones of the plurality of the group IDs stored by the group ID storage device includes a communication address of the communication device storing the corresponding one of the plurality of group IDs,
wherein the processor is configured to perform:
transmitting a plurality of image data aggregated for the respective ones of the plurality of the group IDs to the respective ones of communication addresses correlated with the respective ones of the group IDs stored in the group ID storage device.

8. A data aggregation method in a server apparatus, comprising:
receiving a group ID and a plurality of calculation data corresponding to the group ID from a communication device;
registering the plurality of received calculation data correlated with the received group ID; and
transmitting image data acquired by aggregating the plurality of registered calculation data for the group ID.

9. The data aggregation method according to claim 8,
wherein the server apparatus includes a group ID storage device that stores (i) a plurality of group IDs including the group ID and (ii) a plurality of items of transmission destination information correlated with the respective ones of the plurality of group IDs, and
the transmitting of a plurality of image data includes transmitting a plurality of image data aggregated for the respective ones of the plurality of the group IDs to the respective ones of the plurality of items of transmission destination information.

10. The data aggregation method according to claim 9, further comprising:
registering each of the plurality of the group IDs and each of the plurality of items of the transmission destination information correlated with the respective ones of the plurality of group IDs in the group ID storage device in accordance with a user operation.

11. The data aggregation method according to claim 8, further comprising:
receiving seating data and individual device IDs of information display devices together with the group ID and registering a seating table in which the individual device IDs of the information display devices are correlated with respective seats,
wherein the image data is acquired by arranging the plurality of calculation data at positions of seats of the respective individual devices ID of the registered seating table.

12. The data aggregation method according to claim 8,
wherein a unit of the plurality of calculation data is one of table data of statistic calculation and calculation result data of the table data, and
the transmitting of aggregated image data is generating a graph image configured by plot points of the table data and a graph corresponding to the plot points in a case in which the unit of the plurality of calculation data is the table data of the statistic calculation and generating a graph image configured by a graph corresponding to the plurality of calculation result data in a case in which the unit of the plurality of calculation data is the calculation result data of the statistic calculation and transmitting the graph image.

13. The data aggregation method according to claim 8,
wherein the communication device acquires the plurality of calculation data from the information display devices by imaging a two-dimensional code image generated based on the plurality of calculation data displayed on respective display units of the information display devices
the receiving of the plurality of calculation data and the group ID includes receiving code data of the two-dimensional code images displayed by the respective information display devices and the group ID correlated with the plurality of calculation data corresponding to the respective two-dimensional code images.

14. The data aggregation method according to claim 9,
each of the plurality of items of the transmission destination information correlated with the respective ones of the plurality of group IDs stored by the group ID storage device being a communication address of the communication device storing the corresponding one of the plurality of group IDs,
wherein the image data are aggregated for the respective ones of the plurality of the group IDs to the respective ones of communication addresses correlated with respective ones of the group IDs stored in the group ID storage device.

15. A communication device comprising:
a receiver; and
a transmitter;
wherein the receiver receives a plurality of calculation data from a plurality of information display,
wherein the transmitter transmits a group ID and the plurality of calculation data correlated with the group ID to a server apparatus,
wherein the server apparatus that includes a processor configured to perform:
receiving the group ID and the plurality of calculation data corresponding to the group ID from the communication device;
registering the plurality of calculation data correlated with the received group ID; and
transmitting image data acquired by aggregating the plurality of registered calculation data for the group ID.
